(19) United States
(12) Patent Application Publication
(10) Pub. No.: US 2018/0157105 A1
(43) Pub. Date: Jun. 7, 2018

(54) LIQUID CRYSTAL DISPLAY PANEL AND METHOD FOR MANUFACTURING THE SAME

(71) Applicant: Shenzhen China Star Optoelectronics Technology Co., Ltd., Shenzhen (CN)

(72) Inventors: Xingwu CHEN, Shenzhen (CN); Xiaolong MA, Shenzhen (CN)

(73) Assignee: Shenzhen China Star Optoelectronics Technology Co., Ltd., Shenzhen (CN)

(21) Appl. No.: 14/897,473

(22) PCT Filed: Aug. 13, 2015
(86) PCT No.: PCT/CN2015/086833

§ 371 Date: Dec. 10, 2015

(30) Foreign Application Priority Data
Aug. 5, 2015 (CN) 201510473593.8

(51) Int. Cl. G02F 1/1335; G02F 1/1368

(52) U.S. Cl. CPC G02F 1/133516; G02F 2202/28; G02F 1/133512; G02F 1/1368

(57) ABSTRACT

In order to improve the use ratio of light of the quantum dot liquid crystal display panel, a quantum dot liquid crystal display panel and a method for manufacturing the quantum dot liquid crystal display panel are provided. The liquid crystal display panel includes a liquid crystal cell and a color filter substrate. The liquid crystal cell includes a first glass plate, a second glass plate, and an liquid crystal interlayer sandwiched between the first glass plate and the second glass plate, the first glass plate being provided with thin film transistor array thereon; and the color filter substrate is laminated on a side of the second glass plate that is facing away from the liquid crystal interlayer by a pressure laminating layer. The color gamut and the use ratio of light of the liquid crystal display device can be effectively improved according to the liquid crystal display panel and a method for manufacturing the same.

### CROSS REFERENCE TO RELATED APPLICATION

The present application claims the priority of Chinese patent application CN 201510473593.8, entitled “A Liquid Crystal Display Panel and A Method for Manufacturing the Same” and filed on Aug. 5, 2015, the entirety of which is incorporated herein by reference.

### TECHNICAL FIELD

The present disclosure relates to the technical field of liquid crystal display, and in particular to a liquid crystal display panel and a method for manufacturing the liquid crystal display panel.

### TECHNICAL BACKGROUND

As display technology develops rapidly, people's requirement of display technology is higher and higher. Liquid crystal display technology has become the most extensively applied display technology at present. High color gamut and high brightness are the main direction of development of the current display technology.

In order to improve the color gamut and the brightness of a display panel, organic light emitting diode (OLED) display technology sprung up. However, a display device using OLED has the defects of low yield and limited service life, which have been difficult problems. As a result, most display panel manufacturers sit on a fence about it.

Another high color gamut display technology is quantum dots liquid crystal display mode. Quantum dots, which are also called nanocrystalline, consist of nanoparticles having a particle size in a range of 1-20 nm. Due to quantum confinement of electron and cavity, an energy band structure of a quantum dot is divided into independent level structures, whereby the quantum dot can emit fluorescence when excited. An emission spectrum of the quantum dot mainly depends on a particle size of the quantum dot. In this case, the emission spectrum can be regulated by changing the particle size of the quantum dot. In the meantime, quantum dot has high light conversion efficiency, whereby a use ratio of light can be improved. However, since quantum dot material can change a polarization state of light, the use ratio of light would be influenced if the quantum dot material is directly applied in a liquid crystal panel in the prior art.

### SUMMARY OF THE INVENTION

In order to improve the use ratio of light of a quantum dot liquid crystal display panel, the present disclosure provides a quantum dot liquid crystal display panel and a method for manufacturing the quantum dot liquid crystal display panel.

The liquid crystal display panel according to the present disclosure comprises a liquid crystal cell and a color filter substrate, wherein the liquid crystal cell comprises a first glass plate, a second glass plate, and a liquid crystal interlayer sandwiched between the first glass plate and the second glass plate, the first glass plate being provided with a thin film transistor array thereon; and the color filter substrate is laminated on a side of the second glass plate that is facing away from the liquid crystal interlayer by a pressure laminating layer.

Preferably, the color filter substrate comprises: a third glass plate; a red quantum dot layer, a green quantum dot layer, and a blue quantum dot layer which are disposed in a staggered manner with respect to one another on a side of the third glass plate that is facing the liquid crystal cell for at least one pixel; and a black matrix disposed between the red, green and blue quantum dot layers, and the third glass plate, the black matrix being situated at seams formed between two of the red quantum dot layer, green quantum dot layer, and the blue quantum dot layer.

The red quantum dot layer can be excited to emit red light, the green quantum dot layer can be excited to emit green light, and the blue quantum dot layer can be excited to emit blue light. In a pixel unit, the coloring function of the color filter substrate can be performed by coordination between the quantum dot layers of the three primary colors.

Current quantum dot material emits light mainly through a photoilluminescence process. If the quantum dot material is disposed inside the liquid crystal cell, polarization state of the light will be changed. If a polarizer is added downstream of the quantum dot material, a light conversion efficiency will be reduced. However, in the liquid crystal display panel according to the present disclosure, the pressure laminating layer is intentionally used to laminate the color filter made from the quantum dot material on an outer side of the liquid crystal cell, thereby avoiding the abovementioned dilemma. As a result, not only the light conversion efficiency is effectively improved, the difficulty for manufacturing is also reduced.

Preferably, a material of the pressure laminating layer is one or a mixture comprising more than two selected from a group consisting of urethane pressure-sensitive adhesive, acrylic acid pressure-sensitive adhesive, rubber pressure-sensitive adhesive, polyvinyl ether pressure-sensitive adhesive, polyisobutene pressure-sensitive adhesive, epoxy pressure-sensitive adhesive, phenois pressure-sensitive adhesive, silicon pressure-sensitive adhesive, and polyester pressure-sensitive adhesive. Specifically, the rubber pressure-sensitive adhesive comprises butadiene styrene rubber and/or phenylethylene-butadiene rubber.

Preferably, the pressure laminating layer is formed on the side of the color filter substrate that is facing the liquid crystal cell by spin coating, slot coating, or ink-jet printing.

Thus, according to a preferred solution of the present disclosure, the pressure laminating layer can be flexibly arranged. The material of the pressure laminating layer can be selected from a variety of choices, and so is the coating manner thereof. Therefore, the arrangement of the pressure laminating layer, which is the core improvement according to the present disclosure, imposes little limit to the technological process and will not substantially increase the difficulty or cost of the manufacturing process of the liquid crystal display panel.

Preferably, quantum dots in the red quantum dot layer, green quantum dot layer, and the blue quantum dot layer are formed from one or a mixture comprising more than two selected from a group consisting of CdX, PbX, ZnX, HgX, GaX, and InX, wherein X represents S, Se, or Te.

Thus, according to a preferred solution of the present disclosure, the arrangement of the quantum dot layers (the red quantum dot layer, green quantum dot layer, and the blue quantum dot layer) is also very flexible. The material of the quantum dot layer can be selected from a variety of choices, thus will not substantially increase the difficulty or cost of the manufacturing process of the liquid crystal display panel.

The present disclosure further provides a method for manufacturing the abovementioned liquid crystal display panel.

The method comprises steps of preparing the liquid crystal cell, preparing the color filter substrate, and laminating the color filter substrate on the side of the second glass plate that is facing away from the liquid crystal interlayer by a pressure laminating layer.

Preferably, in the step of preparing the liquid crystal cell, a first glass plate and a second glass plate are prepared, an electrode layer and a first liquid crystal alignment layer are formed on the first glass plate, and a second liquid crystal alignment layer and spacers for keeping a thickness of the liquid crystal interlayer are formed on the second glass plate; and the first glass plate and the second glass plate are assembled together, and polarizers are formed respectively on a side of the first glass plate and a side of the second glass plate that are facing away from the liquid crystal interlayer after the assembly.

Preferably, in the step of preparing the color filter substrate, a red quantum dot layer, a green quantum dot layer, and a blue quantum dot layer are disposed in sequence on the third glass plate, and a black matrix is formed at seams formed between two of the red quantum dot layer, green quantum dot layer, and the blue quantum dot layer.

Preferably, the pressure laminating layer is formed on the side of the color filter substrate that is facing the liquid crystal cell by spin coating, slot coating, or ink-jet printing.

The color gamut and the use ratio of light of a liquid crystal display device can be improved with the liquid crystal display panel and the method for manufacturing the liquid crystal display panel according to the present disclosure.

As long as the objective of the present disclosure is met, the above technical features can be combined in any suitable manner or substituted with equivalent technical features.

### BRIEF DESCRIPTION OF THE ACCOMPANYING DRAWINGS

The present disclosure will be described in detail based on the examples in view of the accompanying drawings. In the drawings:

FIG. 1 schematically shows an example of part of a color filter substrate (corresponding to a pixel unit) in a liquid crystal display panel according to the present disclosure,

FIG. 2 schematically shows an example of part of a liquid crystal cell (corresponding to a pixel unit) in the liquid crystal display panel according to the present disclosure, and

FIG. 3 schematically shows an example of part of a liquid crystal display panel (corresponding to a pixel unit) according to the present disclosure, the liquid crystal display panel comprising the color filter substrate and the liquid crystal cell assembled together through a pressure laminating layer.

In the drawings, same components are indicated with the same reference sign. The drawings are not drawn to actual scale.

### DETAILED DESCRIPTION OF THE EMBODIMENTS

The present disclosure will be described in detail in view of the accompanying drawings.

The present disclosure provides a liquid crystal display panel, comprising a liquid crystal cell and a color filter substrate.

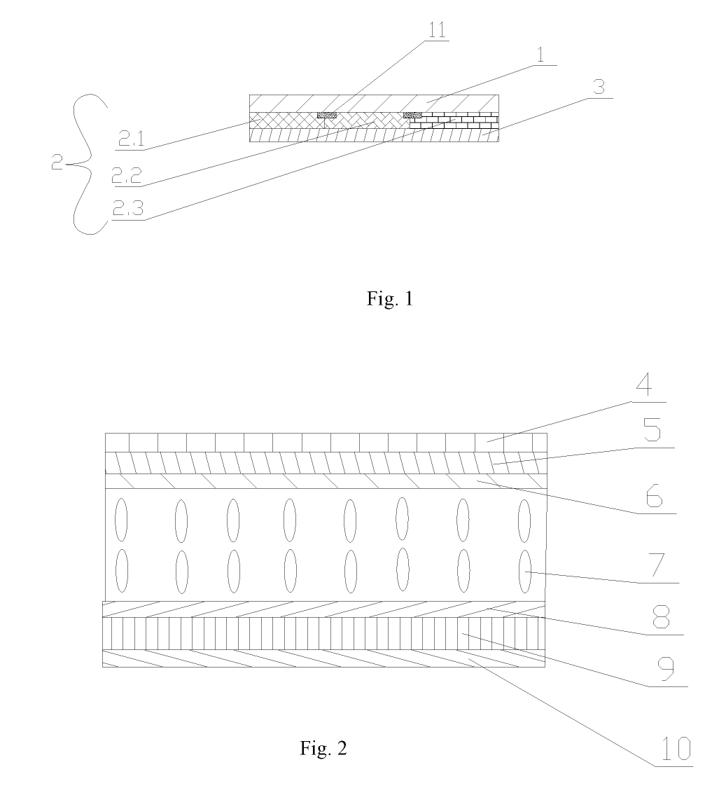

FIG. 1 schematically shows an example of part of a color filter substrate (corresponding to a pixel unit) in a liquid crystal display panel according to the present disclosure. FIG. 1 clearly shows that the color filter substrate comprises a third glass plate 1.

A quantum dot layer 2 is disposed on the third glass plate 1. Specifically, the quantum dot layer 2 comprises a red quantum dot layer 2.1, a green quantum dot layer 2.2, and a blue quantum dot layer 2.3, which are arranged in a staggered manner with respect to one another. The red quantum dot layer 2.1 can be excited to emit red light, the green quantum dot layer 2.2 can be exited to emit green light, and the blue quantum dot layer 2.3 can be excited to emit blue light. The red quantum dot layer 2.1, green quantum dot layer 2.2, and the blue quantum dot layer 2.3 each correspond to a subpixel. Each pixel unit at least comprises a red subpixel, a green subpixel and a blue subpixel. The patterning of the red quantum dot layer 2.1, green quantum dot layer 2.2, and the blue quantum dot layer 2.3 can be realized through photoresist (negative photoresist) contained therein.

A black matrix 11 is disposed between the third glass plate 1 and the red quantum dot layer 2.1, green quantum dot layer 2.2, and the blue quantum dot layer 2.3. The black matrix 11 is situated at seams formed between two of the red quantum dot layer 2.1, the green quantum dot layer 2.2, and the blue quantum dot layer 2.3. The black matrix 11 can be used to prevent light leak, so as to guarantee display quality.

The quantum dot layer 2 (i.e., the red quantum dot layer 2.1, the green quantum dot layer 2.2, and the blue quantum dot layer 2.3) can be formed from one or a mixture comprising more than two selected from a group consisting of CdX, PbX, ZnX, HgX, GaX, and InX, wherein X represents S, Se, or Te.

FIG. 2 schematically shows an example of part of a liquid crystal cell (corresponding to a pixel unit) in the liquid crystal display panel according to the present disclosure. FIG. 2 clearly shows that the liquid crystal cell comprises a first glass plate 9, a second glass plate 5, and a liquid crystal interlayer 7 sandwiched between the first glass plate 9 and the second glass plate 5.

A thin film transistor array is disposed on the first glass plate 9. Specific structure of the thin film transistor array is not relevant to the core of improvement of the present disclosure, thus will not be shown in the drawings.

An alignment film 8 is disposed on a side of the first glass plate 9 that is facing the liquid crystal interlayer 7, and an alignment film 6 is disposed on a side of the second glass plate 5 that is facing the liquid crystal interlayer 7. The alignment film 8 and the alignment film 6 are used for setting a tilt angle of liquid crystals in the liquid crystal interlayer 7.

A first polarizer 10 is disposed on a side of the first glass plate 9 that is facing away from the liquid crystal interlayer 7, and a second polarizer 4 is disposed on a side of the second glass plate 5 that is facing away from the liquid crystal interlayer 7. The first polarizer 10 is used for generating linearly polarized light, which changes polarization direction after passing through the liquid crystal interlayer 7. The second polarizer 4 is used for filtering the polarization direction of light, so that suitable light intensity can be selected.

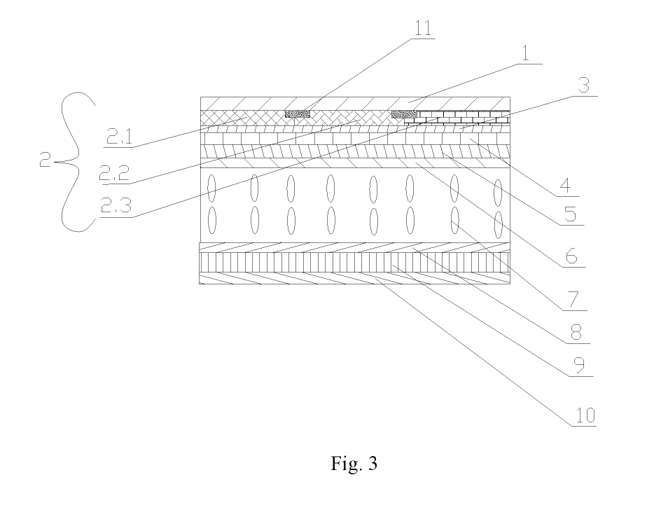

FIG. 3 schematically shows an example of part of a liquid crystal display panel (corresponding to a pixel unit) according to the present disclosure. The liquid crystal display panel comprises the color filter substrate as shown in FIG. 1 and the liquid crystal cell as shown in FIG. 2 assembled together through a pressure laminating layer 3. FIG. 3 clearly shows that the color filter substrate is laminated on the side of the second glass plate 5 that is facing away from the liquid crystal interlayer 7 through the pressuring laminating layer 3.

A material of the pressure laminating layer 3 is one or a mixture comprising more than two selected from a group consisting of urethane pressure-sensitive adhesive, acrylic acid pressure-sensitive adhesive, rubber pressure-sensitive adhesive (the rubber pressure-sensitive adhesive can comprise, for example, butadiene styrene rubber and/or phenylethylene-butadiene rubber), polyvinyl ether pressure-sensitive adhesive, polyisobutene pressure-sensitive adhesive, epoxy pressure-sensitive adhesive, phenois pressure-sensitive adhesive, silicon pressure-sensitive adhesive, and polyester pressure-sensitive adhesive.

The pressure laminating layer 3 can be formed on a side of the quantum dot layer 2 (i.e., the red quantum dot layer 2.1, the green quantum dot layer 2.2, and the blue quantum dot layer 2.3) of the color filter substrate that is facing the liquid crystal cell by spin coating, slot coating, or ink-jet printing.

The present disclosure further proposes a method for manufacturing the liquid crystal display panel. The method comprises the following steps.

In step 1, the liquid crystal cell shown by FIG. 2 is prepared. The liquid crystal cell comprises the first glass plate 9, the second glass plate 5, and the liquid crystal interlayer 7 sandwiched between the first glass plate 9 and the second glass plate 5. The thin film transistor array is disposed on the first glass plate 9.

In an example, the first glass plate 9 and the second glass plate 5 are prepared first in the process of manufacturing the liquid crystal cell. On the first glass plate 9 are disposed an electrode layer (not shown) for forming the thin film transistor array and a first liquid crystal alignment layer 8 (i.e., the alignment film). On the second glass plate 5 are disposed a second liquid crystal alignment layer 6 (i.e., the alignment film) and spacers (not shown) for maintaining a thickness of the liquid crystal interlayer.

Subsequently, the first glass plate 9 and the second glass plate 5 are assembled. After assembly, the polarizer 10 and the polarizer 4 are respectively formed on the sides of the first glass plate 9 and the second glass plate 5 that are facing away from the liquid crystal interlayer 7.

In step 2, the color filter as shown in FIG. 1 is prepared.

In an example, the red quantum dot layer 2.1, the green quantum dot layer 2.2, and the blue quantum dot layer 2.3 are arranged in a staggered manner with respect to one another on the third glass plate 1. The patterning of the red quantum dot layer 2.1, the green quantum dot layer 2.2, and the blue quantum dot layer 2.3 can be realized through photoresist (negative photoresist) contained therein. The black matrix 11 can be disposed at the seams formed between two of the red quantum dot layer 2.1, the green quantum dot layer 2.2, and the blue quantum dot layer 2.3. The black matrix 11 is situated between the third glass plate 1 and the quantum dot layer 2 so as to prevent light leak.

In step 3, the color filter substrate is laminated on the side (an upper part of FIG. 3) of the second glass plate 5 that is facing away from the liquid crystal interlayer 7 through the pressure laminating layer 3. A complete liquid crystal display panel can be obtained after the lamination. Specifically, the pressure laminating layer 3 can be formed on the side of the color filter substrate that is facing the liquid crystal cell by spin coating, slot coating, or ink-jet printing.

Of course, it should be easy to understand that in another example, step 2 can be performed before step 1.

The present disclosure provides the liquid crystal display panel with high color gamut and high brightness, as well as a method for manufacturing the same. The color gamut and the use ratio of light of a liquid crystal display device can be improved by means of the liquid crystal display panel and the method for manufacturing the liquid crystal display panel according to the present disclosure.

The liquid crystal display panel according to the present disclosure adopts the structure of quantum dots. Quantum dots, which are also called nanocrystalline, consist nanoparticles having a particle size in a range of 1-20 nm. Due to quantum confinement of electron and cavity, an energy band structure of a quantum dot is divided into independent level structures, whereby the quantum dot can emit fluorescence when excited. An emission spectrum of the quantum dot mainly depends on a particle size of the quantum dot. In this case, the emission spectrum can be regulated by changing the particle size of the quantum dot. In the meantime, quantum dot has high light conversion efficiency, whereby a use ratio of light can be improved.

In another aspect, the quantum dot has very narrow half-wave width of an emission spectrum thereof and good temperature stability. As compared with pigment or fluorescent powder, quantum dot structure as luminescent material, measured by standards of the US National Television Standard Committee (NTSC), enables the liquid crystal display panel to have a color gamut of over 100%. At present, the liquid crystal display panel in the market generally has a color gamut of merely 70%. Thus, the color gamut of the liquid crystal display panel according to the present disclosure improved at least by 30% as compared with the display panel in the prior art.

More importantly, current quantum dot material emits light mainly through a photoilluminescence process. If the quantum dot material is disposed inside the liquid crystal cell, the polarization state of light will be changed. If a polarizer is added downstream of the quantum dot material, a light conversion efficiency will be reduced. However, in the liquid crystal display panel according to the present disclosure, the pressure laminating layer is intentionally used to laminate the color filter substrate formed from the quantum dot layer on an outer side of the polarizer 4, thereby avoiding the abovementioned dilemma. As a result, not only the light conversion efficiency is effectively improved, the difficulty for manufacturing is also reduced.

The present disclosure has been described with reference to preferred embodiments, which are only examples for illustrating the principle and application of the present disclosure. It should be understood that various modifications and variants to the present disclosure may be made by anyone skilled in the art, without departing from the scope and spirit of the present disclosure. In particular, various dependent claims and technical features described herein may be combined with one another in any different manner from the original claims. It should also be understood that the technical features described in view of a single example can also be applied to other examples.

1. A liquid crystal display panel, comprising a liquid crystal cell and a color filter substrate, wherein
the liquid crystal cell comprises a first glass plate, a second glass plate, and an liquid crystal interlayer sandwiched between the first glass plate and the second glass plate, the first glass plate being provided with thin film transistor array thereon, and
the color filter substrate is laminated on a side of the second glass plate that is facing away from the liquid crystal interlayer by a pressure laminating layer.

2. The liquid crystal display panel according to claim 1, wherein the color filter substrate comprises:
a third glass plate,
a red quantum dot layer, a green quantum dot layer, and a blue quantum dot layer that are disposed in a staggered manner with respect to one another on a side of the third glass plate that is facing the liquid crystal cell for at least one pixel, and
a black matrix disposed between the red quantum dot layer, the green quantum dot layer and the blue quantum dot layer, and the third glass plate, the black matrix being situated at seams formed between two of the red quantum dot layer, the green quantum dot layer, and the blue quantum dot layer.

3. The liquid crystal display panel according to claim 1, wherein a material of the pressure laminating layer is one or a mixture comprising more than two selected from a group consisting of urethane pressure-sensitive adhesive, acrylic acid pressure-sensitive adhesive, rubber pressure-sensitive adhesive, polyvinyl ether pressure-sensitive adhesive, polyisobutene pressure-sensitive adhesive, epoxy pressure-sensitive adhesive, phenois pressure-sensitive adhesive, silicon pressure-sensitive adhesive, and polyester pressure-sensitive adhesive.

4. The liquid crystal display panel according to claim 3, wherein the rubber pressure-sensitive adhesive comprises butadiene styrene rubber and/or phenylethylene-butadiene rubber.

5. The liquid crystal display panel according to claim 3, wherein the pressure laminating layer is formed on the side of the color filter substrate that is facing the liquid crystal cell by spin coating, slot coating, or ink-jet printing.

6. The liquid crystal display panel according to claim 2, wherein quantum dots in the red quantum dot layer, the green quantum dot layer, and the blue quantum dot layer are formed from one or a mixture comprising more than two selected from a group consisting of CdX, PbX, ZnX, HgX, GaX, and InX, wherein X represents S, Se, or Te.

7. A method for manufacturing a liquid crystal display panel, wherein
the liquid crystal display panel comprises a liquid crystal cell and a color filter substrate, wherein the liquid crystal cell comprises a first glass plate, a second glass plate, and an liquid crystal interlayer sandwiched between the first glass plate and the second glass plate, the first glass plate being provided with thin film transistor array thereon; and the color filter substrate is laminated on a side of the second glass plate that is facing away from the liquid crystal interlayer by a pressure laminating layer, and
the method comprises steps of:
preparing the liquid crystal cell,
preparing the color filter layer, and
laminating the color filter layer on the side of the second glass plate that is facing away from the liquid crystal interlayer by a pressure laminating layer.

8. The method according to claim 7, wherein in the step of preparing the liquid crystal cell:
a first glass plate and a second glass plate are prepared, an electrode layer and a first liquid crystal alignment layer are formed on the first glass plate, and a second liquid crystal alignment layer and spacers for keeping a thickness of the liquid crystal interlayer are formed on the second glass plate; and
the first glass plate and the second glass plate are assembled together, and polarizers are formed respectively on a side of the first glass plate and a side of the second glass plate that are facing away from the liquid crystal interlayer.

9. The method according to claim 7, wherein in the step of preparing the color filter substrate, a red quantum dot layer, a green quantum dot layer, and a blue quantum dot layer are disposed in sequence on the third glass plate, and a black matrix is formed at seams formed between two of the red quantum dot layer, the green quantum dot layer, and the blue quantum dot layer.

10. The method according to claim 7, wherein the pressure laminating layer is formed on the side of the color filter substrate that is facing the liquid crystal cell by spin coating, slot coating, or ink-jet printing.
